(19) United States
(12) Patent Application Publication
(10) Pub. No.: US 2004/0032341 A1
(43) Pub. Date: Feb. 19, 2004

(54) Sensor head, control module and multiple sensor

(76) Inventors: Thomas Brenner, Furth (DE); Karl-Heinz Dausch, Schwarzenfeld (DE); Manfred Schmitt, Hahnbach (DE)

Correspondence Address: HARNESS, DICKEY & PIERCE, P.L.C., P.O.BOX 8910, RESTON, VA, 20195, US

(21) Appl. No.: 10/380,270

(22) PCT Filed: Aug. 30, 2001
(86) PCT No.: PCT/DE01/03332

(30) Foreign Application Priority Data
Sep. 12, 2000 (DE) 100 45 097.0

(51) Int. Cl. G08C 19/00

(52) U.S. Cl. 340/870.11; 73/866.1; 340/870.3; 340/870.4; 340/870.16; 702/116; 702/189

(57) ABSTRACT

A sensor head includes a sensor element whose measurement signal can be fed to a comparator. The comparator compares the measurement signal to a threshold value and forwards a binary output signal to a transmission circuit. The sensor head is provided with electric energy via a proprietary two-wire line. In addition, the output signal can be transmitted from the transmission circuit via the two-wire line to a higher-order control module that is located outside of the sensor head. At least two sensor heads of this type can be connected to the control module.

This application is the national phase under 35 U.S.C. § 371 of PCT International Application No. PCT/DE01/03332 which has an International filing date of Aug. 30, 2001, which designated the United States of America and which claims priority on German Patent Application number DE 100 45 097.0 filed Sep. 12, 2000, the entire contents of which are hereby incorporated herein by reference.

### FIELD OF THE INVENTION

The present invention generally relates to a sensor head. Preferably, it relates to one having a sensor element whose measuring signal can be fed to a comparator, by which the measuring signal can be compared with a threshold value and a binary output signal can be forwarded to a transfer circuit. It further generally relates to a control module for at least two sensor heads and to a multiple sensor formed from a control module and at least two sensor heads.

### BACKGROUND OF THE INVENTION

Sensors, by which a binary output signal can be transmitted to a higher-level control module, so-called binary sensors, are used in large numbers of items for automation purposes, for example in the automobile industry or in machine tool building. In this case, the sensors are connected to the controller or to a de-central peripheral module either via conventional parallel wiring or via a field bus system.

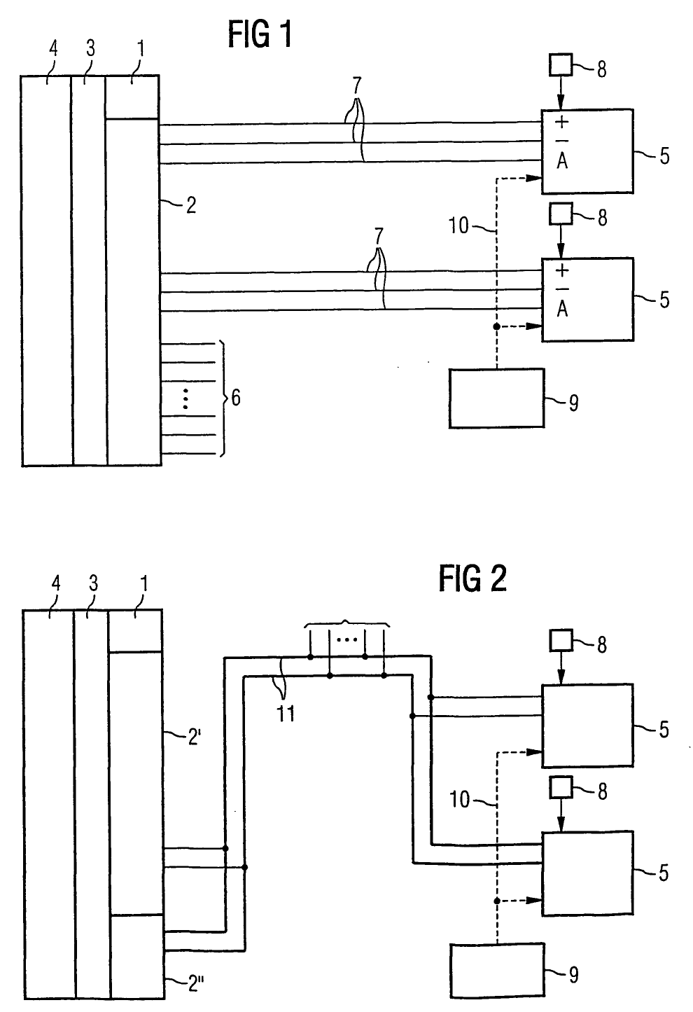

A part of a parallel-wired system is illustrated schematically in FIG. 1. It has a central unit 1 with an input/output module 2. The central unit 1 and the module 2 are interconnected and connected to a power supply module 4 via an internal control bus 3. Not illustrated in FIG. 1 are actuators (for example solenoid valves) that are present in virtually every installation. Two sensors 5 are illustrated as representative of all further sensors, for which only terminals 6 are indicated symbolically.

The connection between the module 2 and the sensors 5 is performed as a rule via a three-wire line 7. Two of these lines serve the purpose of power supply, while the binary signal is transmitted from the sensor 5 to the module 2 via the third one. During installation, it must be borne in mind that the individual lines of the three-wire line 7 are correctly connected, since otherwise malfunctions, in the extreme case even destruction, of the sensors can occur.

As a rule, the sensors are certainly provided with protective measures such as polarity reversal protection and short-circuit protection, but this is relatively costly.

Furthermore, it is possible in the case of so-called intelligent sensors to use a so-called teach-in operation (for example by pressing a key 8 at the respective sensor 5) specifically to set a switching threshold at which the respective sensor 5 responds. However, as previously stated, the signal transmitted as such by the sensor 5 remains binary.

In the case of a plurality of intelligent sensors 5 in a system, each individual sensor 5 must be parameterized on site by a teach-in. If a sensor 5 becomes defective and needs to be exchanged, a renewed teach-in operation is necessary, since the threshold value is stored only in the sensor 5 itself.

The sensors 5 can be based on different functional principles. For example, they can be optical sensors 5. In operation, optical sensors 5 emit an appropriately short light pulse, generally periodically, only in a short time window. The time window is controlled by a clock stage inside the sensor. The detection of the emitted light also only takes place in this time window. However, since all the sensors 5 work autonomously and are not normally synchronized or triggered, in some circumstances reciprocal influencing can arise when the time windows of two sensors 5 accidentally coincide and a sensor 5 detects the light pulse of another sensor 5 (crosstalk).

The problem of crosstalk can be eliminated by having additional control inputs present at the respective sensors 5. Drive pulses are transmitted via the additional control inputs to the individual sensors 5 from an additional control unit 9 via additional control lines 10. The sensors 5 can thereby be driven in a temporally staggered fashion such that crosstalk is virtually excluded.

A disadvantage of the design in accordance with FIG. 1 resides in that the so-called control penetration ends at the input/output module 2. Thus, the central unit 1 cannot detect whether, for example, a sensor fault is present or the line to the sensor 5 is interrupted.

FIG. 2 shows a similar control system to that of FIG. 1. However, by contrast with FIG. 1, here the output signals are transmitted via a field bus 11, that is to say a two-wire line common to all the sensors 5. The input/output module 2 is replaced in this case by a field bus master 2′ to which a dedicated field bus power supply 22′ is assigned. The field bus 11 can operate, for example, in accordance with the so-called AS-i protocol.

The field bus master 2′ controls only the data exchange between the central unit 1 and the actuators (also not illustrated in FIG. 2) and the sensors 5. There is no possessing and combining of data by the field bus master 2′.

Because of the bidirectional data exchange between the field bus master 2′ and the sensors 5, it is possible in principle for diagnostic information and parameter values, in particular the threshold values, also to be transmitted in addition to the output signals. However, this must be appropriately controlled in every case by the central unit 1. It is also possible in principle to trigger the sensors 5 specifically, but, here as well, this must be appropriately controlled by the central unit 1. In this case, the user program cycle time therefore results as the smallest possible trigger pulse preparation. It is therefore virtually impossible for the sensors 5 to detect objects in real time. Consequently, as a result the additional control unit 9 must be provided alongside the additional control lines 10 even in the case of the implementation in accordance with FIG. 2.

### SUMMARY OF THE INVENTION

It is an object of an embodiment of the present invention to create a multiple sensor and the components thereof, specifically a sensor head and a control module, by which it is possible in a simple way to operate the individual sensors or sensor heads of the multiple sensor independently of one another, flexibly and conveniently.

An object may be achieved for the sensor by virtue of the fact that it can be supplied with electric energy via a preparatory two-wire line, it being possible for the output signal to be transmitted from the transmission circuit via the two-wire line to a higher-level control module outside the sensor head.

In a way corresponding to this, an object may also be achieved by use of a control module for at least two sensor heads, wherein the sensor heads can be supplied with electric energy by the control module via proprietary two-wire lines. It is further possible for binary output signals of the sensor heads to be transmitted to the control module via the two-wire lines. Also, it is possible for the output signals to be forwarded to a higher-level central unit outside the control module.

The multiple sensor preferably comprises a control module and at least two sensor heads that are connected to the control module via a proprietary two-wire line in each case.

The output signal can be detected at defined instants when, via the two-wire line, the control module can initiate reading the binary output signal into the transmission circuit with subsequent transmission to the control module.

The sensor heads can be triggered independently of one another when the control module can initiate reading the binary output signals into the sensor heads with subsequent transmission to the control module for each sensor head separately. It is thereby possible, in particular, to drive the sensor heads simultaneously or in a temporally staggered fashion.

Fault detection is possible when the control module can detect a sensor fault when the binary output signals are absent after expiry of a predetermined time interval after an initiation of reading the binary output signals into the sensor heads with subsequent transmission to the control module.

The threshold value can be set in a simple way when it is possible for the control module to transmit the threshold value to the sensor heads (13) via the two-wire lines.

When it is possible for the transmission circuit to request the transmission of threshold values from the control module via the two-wire lines, automatic parameterization of the sensor head is possible when reconnecting the sensor head to the control module.

Diagnosis inside a sensor head together with transmission of the diagnosis to the control module are possible when it is also possible for a diagnostic report to be transmitted by the transmission circuit to the control module via the two-wire lines.

When, in response to a request from the control module, it is possible for the transmission circuit also to transmit the threshold value to the control module via the two-wire line, it is possible to learn the threshold value only via one of the sensor heads. Thereafter, the learned threshold value are automatically forwarded to all the other connected sensor heads.

The data transmission is particularly efficient when the information is transmitted via the two-wire line in an address-free fashion. The address-free transmission of information is possible in this case because the two-wire lines are preparatorily assigned to the respective sensor heads.

The design of the sensor element is arbitrary in principle. However, it is frequently designed as an optical sensor element.

The two conductors of the two-wire line can be connected without regard to polarity when a rectifier unit is arranged between the transmission circuit and the two-wire line.

The sensor head can be configured in a particularly cost-effective fashion when it is possible for an effective sensor signal to be determined for each sensor head with the aid of the output signal transmitted by this sensor head and at least one output signal previously transmitted by the same sensor head.

The central unit can be relieved of data processing tasks, and the cycle time can thus be shortened, when the sensor signals assigned to the sensor heads can be logically combined with one another by the control module and/or can be checked for plausibility, and the result of the combination and/or of the plausibility check can be forwarded to the central unit.

Further advantages and details emerge from the following description of an exemplary embodiment in conjunction with the drawings in which, in terms of principle:

FIGS. 1 and 2 show control systems of the prior art,

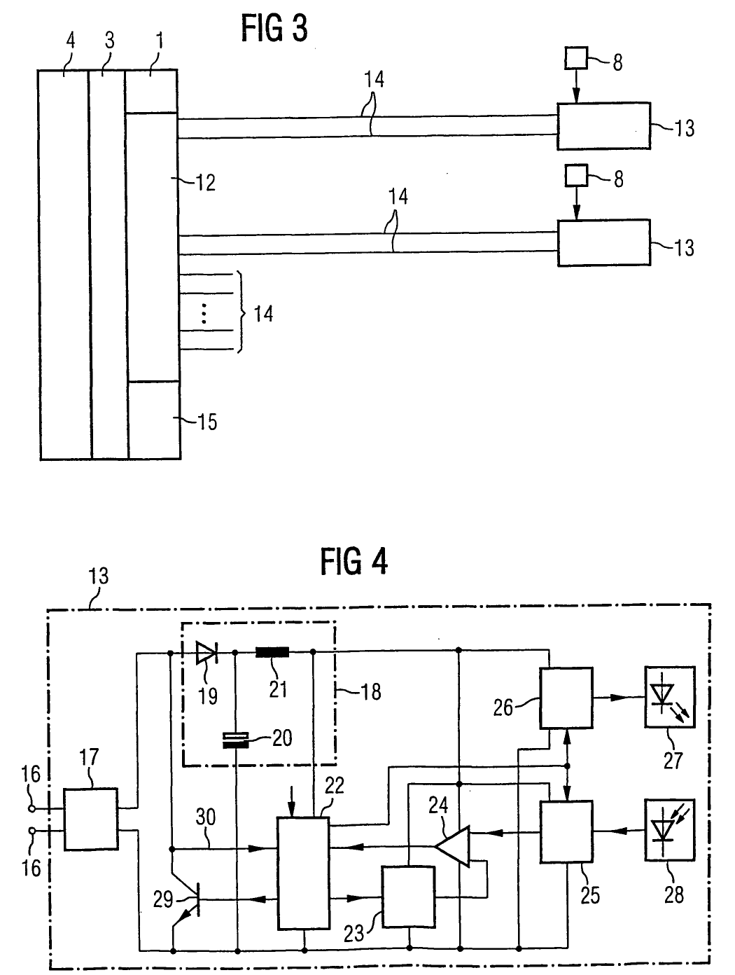

FIG. 3 shows a control system with a multiple sensor,

FIG. 4 shows a sensor head,

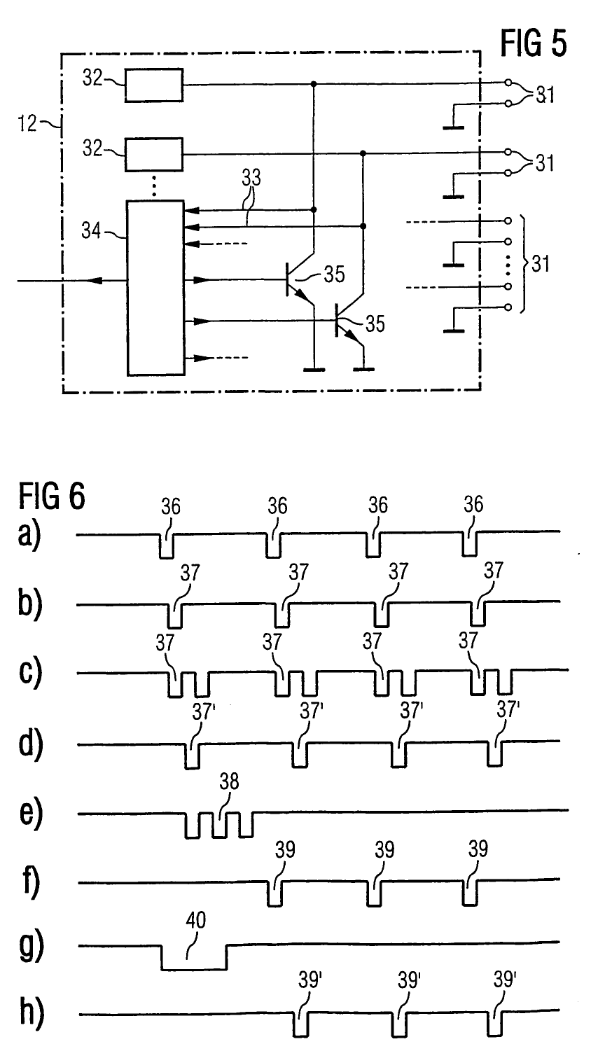

FIG. 5 shows a control module, and

FIGS. 6a-6h show signal shapes of a two-wire line.

### DETAILED DESCRIPTION OF THE PREFERRED EMBODIMENTS

In accordance with FIG. 3, a multiple sensor includes a control module 12 and a plurality of sensor heads 13. In this case, only two sensor heads 13 are illustrated in FIG. 3, but the number of sensor heads 13 is arbitrary in principle. The sensor heads 13 are connected to the control module 12 via proprietary two-wire lines 14. The two-wire lines 14, which are proprietarily assigned to each sensor head 13, both supply the sensor head 13 with electric energy and transmit data between the control module 12 and the respective sensor head 13.

The control module 12 is connected to the central unit 1 and the power supply module 4 via the control bus 3. The central unit 1 is further connected to at least one output module 15 via the control bus 3. However, it is not this output module 15 that is important within the scope of the present invention. For this reason, said module will not be further examined below.

In accordance with FIG. 4, each sensor head 13 has two terminals 16 for the two-wire line 14. A rectifier unit 17 is connected immediately downstream of the terminals 16. The two-wire line 14 is briefly short-circuited in order to transmit information (the details will be further examined later in conjunction with FIG. 6). A voltage dip therefore occurs. A voltage stabilizer 18 is therefore connected downstream of the rectifier unit 17 in order to avoid dips in energy supply during these times. In the simplest case, the voltage stabilizer 18 includes a return-flow blocking diode 19, a back-up capacitor 20 and an inductor 21. The voltage stabilizer 18 renders possible a stable voltage supply of the further components of the signal head 13, specifically a transmission circuit 22, a DA converter 23, a comparator 24, an amplifier 25 and a drive stage 26.

When, as illustrated in FIG. 4, the drive stage 26 drives a light-emitting or laser diode 27, the latter emits light. The light is detected by a photodiode 28 if the light path between the diodes 27, 28 is not interrupted. The photodiode 28 constitutes the sensor element of the sensor head 13. It is thus designed as an optical sensor element. However, in principle, the sensor element can also operate according to another functional principle.

The photodiode 28 outputs, on the basis of the detected light, a measuring signal that is fed to the comparator 24—after appropriate amplification by the amplifier 25. The comparator 24 compares the measuring signal with a threshold value that is fed to the comparator 24 by the transmission circuit 22 via the DA converter 23. The comparator 24 forwards a binary output signal to the transmission circuit 22. The output signal has the value 1 or the value 0, depending on whether the measuring signal is greater or less than the threshold value.

The transmission circuit 22 transmits the output signal to the control module 12 via the two-wire line 14. For this purpose, a switching element 29 is briefly closed such that the voltage present on the two-wire line 14 briefly dips. This will be gone into in more detail later. It is pointed out further by way of supplement at this juncture that data transmissions from the higher-level control module 12 to the respective transmission circuit 22 can be detected by way of a tapping line 30 by the transmission circuit 22.

In accordance with FIG. 5, the control module 12 firstly has corresponding terminals 31 for each two-wire line 14. One each of the terminals 31 is connected to frame or to a current-limiting circuit 32 belonging to the respective two-wire line 14. The power loss of the two-wire lines 14 is limited to a non-critical value by way of the current-limiting circuit 32 in the case both of data transmission and of a short circuit. Furthermore, they effect a good signal-to-noise ratio.

Data transmitted by the transmission circuit 32 are read into a processing unit 34 via tapping lines 33 assigned to one terminal pair 31 each. The output of data to the respective sensor heads 13 is performed via switching elements 35 that can be driven by the processing unit 34.

The interaction of the control module 12 with a sensor head 13 is explained in more detail below in connection with FIG. 6. In this case, of course, the functional principle explained for one sensor head 13 can be transferred directly to the other sensor heads 13. Furthermore, the data transmissions are independent of one another owing to the proprietary assignment of the two-wire lines 14 to the respective sensor heads 13. In particular, it is also possible thereby for the initiation, described below, of reading in a binary output signal with subsequent transmission to the control module 12 to be initiated separately. Driving that is simultaneous, temporally offset or purely stochastic is thereby possible, in particular.

In accordance with FIG. 6a, the control module 12 transmits a trigger pulse 36 to the transmission circuit 22 from time to time by appropriately driving the corresponding switching element 35. The circuit drives the drive stage 26 thereupon. That is to say it initiates reading the binary output signal into the transmission circuit 22, and subsequently transmits the read-in output signal further to the control module 12. In accordance with FIGS. 6b and 6c, an acknowledgement signal 37 is firstly transmitted via the two-wire line 14 for the purpose of transmitting the output signal to the control module 12. Moreover, the two-wire line 14 is once again briefly short-circuited or not at a short time interval after the acknowledgement signal 37, depending on the value of the output signal.

The transmission circuit 22 is capable, inter alia, of carrying out a diagnosis inside a sensor head. If this diagnosis inside the sensor head reveals that the sensor head 13 is not functioning properly, according to FIG. 6d, the transmission circuit 22 outputs a delayed acknowledgement signal 37′. The control module 12 can therefore distinguish between a fault report by the transmission circuit 22 and a normal acknowledgement signal 37 by detecting the time that passes up to the transmission of the acknowledgement signal 37 or of the delayed acknowledgement signal 37′. When, by contrast, no acknowledgement signal 37, 37′ is transmitted at all, the control module detects a sensor fault after expiry of a predetermined, longer time interval after a trigger pulse 36. In this case, either the two-wire line 14 is interrupted, or the sensor head 13 does not react at all.

When the sensor head 13 receives a trigger pulse 36 for the first time after connection to the control module 12, the transmission circuit 22 transmits a pulse train 38 illustrated in FIG. 6e. The pulse train 38 is interpreted by the control module 12 as a request for transmission of the threshold value. In accordance with FIG. 6f, the control module 12 therefore subsequently transmits a train of counting pulses 39 to the transmission circuit 22. The number of the counting pulses 39 yields the value to which the threshold value is to be set.

The transmission of the threshold value can take a certain time, depending on the number of possible counting pulses 39. This can be tolerated, however, since the transmission of a threshold value is necessary as a rule only when commissioning the sensor head 5.

Furthermore, in accordance with FIG. 6g, the control module 12 can short-circuit the two-wire line 14 for a lengthy time interval 40 and long pulse 40 below. The transmission of such a long pulse 40 to the transmission circuit 22 is to be interpreted by the latter as a request for transmission of the threshold already stored in the sensor head 5. In accordance with FIG. 6h, the transmission circuit 22 thereupon transmits a train of counting pulses 39′ to the control module 12. Here, as well, the threshold value can again be given by the number of the counting pulses 39′. Given a setting of the threshold value directly in the sensor head 13, for example via the pushbutton 8, it is therefore possible to set this once in a sensor head 13, and then to transmit it to the control module 12 and thereafter to forward the threshold value from the control module 12 to the other sensor heads 13.

The entire data transmission described above in connection with FIG. 6, is performed via the two-wire line 14 belonging to the respective sensor head 13. Depending on which of the switching elements 29, 35 is closed, data transmission takes place from the sensor head 13 to the control module 12, or vice versa. Clearly, it is exclusively data and not addresses that are transmitted via the two-wire line 14 in this case. The transmission of information is therefore performed in an address-free fashion.

The output signals (if appropriate, also the diagnosis signals and fault detections) transmitted to the control module 12 are forwarded, from the control module 12 to the central unit 1. However, before this, for each sensor head 13, the control module 12 determines an effective sensor signal with the aid of the output signal transmitted by this sensor head and at least one further output signal previously transmitted by the same sensor head 13. It is possible thereby for brief disturbances to be detected and filtered out effectively. For example, it is possible in this case to use only the last output signal, transmitted immediately before, or it is also possible to use further output signals.

If appropriate, the sensor signals can also be evaluated in an even further reaching way by the control module 12. In particular, for example, the sensor signals can be logically combined with one another and the result of combination can be forwarded to the central unit 1. For example, it is possible to deduce the direction of rotation of a shaft from a signal sequence of two sensor heads 13, and to forward only this direction-of-rotation signal, that is to say an increment, to the central unit 1. Again, the signals can be checked for plausibility, and the result of the plausibility check can be forwarded to the central unit 1. When, for example, one sensor head 13 each is assigned to a mover element with reference to its end position, given proper functioning of the sensor heads 13 and of the mover element, it is impermissible for both sensor heads 13 to detect the presence of the mover element simultaneously. If this is in fact the case, a fault is present that can be detected by this plausibility check.

Furthermore, a diagnostic mode of the sensor head 13 is possible in which, given a defined, constant driving of the light-emitting or laser diode 27, a limiting threshold value is determined for which the output signal just has precisely the value 1. The output signal vanishes when the limiting threshold value is increased by 1. The strength of the measuring signal and thus, indirectly, the quality of the sensor element 28 can therefore be detected in this diagnostic mode. Thus, for example, the quality of the optical system and/or contamination of the optical system can be deduced, for example in the case of an optical sensor element 28.

This diagnostic mode is preferably only initiated by the control module by transmission of an appropriate command. The further diagnosis is carried out automatically by the transmission circuit 22. Only the limiting threshold value is transmitted back to the control module 12.

A compact and convenient design of a binary sensor system is possible in a simple and cost-effective way by means of the multiple sensor according to the invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A sensor head having a sensor element (28) whose measuring signal can be fed to a comparator (24) by means of which the measuring signal can be compared with a threshold value and a binary output signal can be forwarded to a transfer circuit (22), it being possible to supply the sensor head with electric energy via a proprietary two-wire line (14), it being possible for the output signal to be transmitted from the transmission circuit (22) via the two-wire line (14) to a higher-level control module (12) outside the sensor head.

2. The sensor head as claimed in claim 1, characterized in that, via the two-wire line (14), the control module (12) can initiate reading the binary output signal into the transmission circuit (22) with subsequent transmission to the control module (12).

3. The sensor head as claimed in claim 1 or 2, characterized in that the threshold value can be transmitted from the control module (12) to the transmission circuit (22) via the two-wire line (14).

4. The sensor head as claimed in claim 3, characterized in that it is possible for the transmission circuit (22) to request the transmission of the threshold value from the control module (12) via the two-wire line (14).

5. The sensor head as claimed in one of the above claims, characterized in that it is also possible for a diagnostic report to be transmitted to the control module (12) from the transmission circuit (22) via the two-wire line (14).

6. The sensor head as claimed in one of the above claims, characterized in that, upon a request from the control module (12), the threshold value can be transmitted from the transmission circuit (22) to the control module (12) via the two-wire line (14).

7. The sensor head as claimed in one of the above claims, characterized in that the transmission of information via the two-wire line (14) is performed in an address-free fashion.

8. The sensor head as claimed in one of the above claims, characterized in that the sensor element (28) is constructed as an optical sensor element (28).

9. The sensor head as claimed in one of the above claims, characterized in that a rectifier unit (17) is arranged between the transmission circuit (22) and the two-wire line (14).

10. A control module for at least two sensor heads (13), it being possible for the sensor heads (13) to be supplied with electric energy by the control module via proprietary two-wire lines (14), it being possible for binary output signals of the sensor heads (13) to be transmitted to the control module via the two-wire lines (14), it being possible for the output signals to be forwarded to a higher-level central unit (1) outside the control module.

11. The control module as claimed in claim 10, characterized in that, via the two-wire lines (14), the control module can initiate reading the binary output signals into the sensor heads (13) with subsequent transmission to the control module.

12. The control module as claimed in claim 11, characterized in that reading the binary output signals into the sensor heads (13) with subsequent transmission to the control module can be initiated separately for each sensor head (13).

13. The control module as claimed in claim 11 or 12, characterized in that the control module can detect a sensor fault when the binary output signals are absent after expiry of a predetermined time interval after an initiation of reading the binary output signals into the sensor heads (13) with subsequent transmission to the control module.

14. The control module as claimed in one of claims 10 to 13, characterized in that it is possible for the control module to transmit threshold values to the sensor heads (13) via the two-wire lines (14).

15. The control module as claimed in claim 14, characterized in that it is possible for the sensor heads (13) to request the transmission of threshold values from the control module via the two-wire lines (14).

16. The control module as claimed in one of claims 10 to 15, characterized in that it is also possible for diagnostic reports to be transmitted to the control module via the two-wire lines (14).

17. The control module as claimed in one of claims 10 to 16, characterized in that it is possible for it to request transmissions of threshold values from the sensor heads (13) via the two-wire lines (14).

18. The control module as claimed in one of claims 10 to 17, characterized in that the transmission of information via the two-wire lines (14) is performed in an address-free fashion.

19. The control module as claimed in one of claims 10 to 18, characterized in that it is possible for an effective sensor signal to be determined for each sensor head (13) with the aid of the output signal transmitted by this sensor head (13) and at least one output signal previously transmitted by the same sensor head (13).

20. The control module as claimed in claim 19, characterized in that the sensor signals assigned to the sensor heads (13) can be logically combined with one another by the control module and/or can be checked for plausibility, and in that the result of the combination and/or of the plausibility check can be forwarded to the central unit (1).

21. A multiple sensor comprising a control module (12) according to one of claims 10 to 20 and at least two sensor heads (13) according to one of claims 1 to 9, in which the sensor heads (13) are connected to the control module (12) via a proprietary two-wire line (14) in each case.
